(19) United States
(12) Patent Application Publication
(10) Pub. No.: US 2008/0301691 A1
(43) Pub. Date: Dec. 4, 2008

(54) METHOD FOR IMPROVING RUN-TIME EXECUTION OF AN APPLICATION ON A PLATFORM BASED ON APPLICATION METADATA

(75) Inventors: Stylianos Mamagkakis, Leuven (BE); Vincent Nollet, Westerlo (BE); Diederik Verkest, Winye (BE)

Correspondence Address: KNOBBE MARTENS OLSON & BEAR LLP, 2040 MAIN STREET, FOURTEENTH FLOOR, IRVINE, CA, 92614, US

(73) Assignee: Interuniversitair Microelektronica centrum vzw (IMEC), Leuven (BE)

(21) Appl. No.: 12/129,516

(22) Filed: May 29, 2008

(30) Foreign Application Priority Data
Jun. 1, 2007 (GB) GB 0710417.7

(51) Int. Cl. G06F 9/46; G06F 9/44

(52) U.S. Cl. 718/104; 718/100; 717/129

(57) ABSTRACT

A method for improving run-time execution of an application on a platform based on application metadata is disclosed. In one embodiment, the method comprises loading a first information in a standardized predetermined format describing characteristics of at least one of the applications. The method further comprises generating the run-time manager, based on the first information, the run-time manager comprising at least two run-time sub-managers, each handling the management of a different resource. The information needed to generate the two run-time sub-managers is at least partially shared.

### BACKGROUND OF THE INVENTION

1. Field of the Invention

The method relates to automated design methods for generating (optimized and/or improved) run-time managers, especially suited for management of embedded hardware resources, in the context of improving run-time execution of one or more applications, in particular embedded software applications, on platforms.

2. Description of the Related Technology

The following terms are used interchangeably in the description: static, design-time, compile-time and offline. These terms are used to contrast the following terms, which are also used interchangeably in the description: dynamic, run-time, execution-time and online.

The field of the related technology lies in the abstraction layer between the embedded software applications and the embedded hardware platform. Therefore the Semantic Kernel can be seen as an Interface between the hardware and software components of an embedded system. Therefore, the Semantic Kernel replaces part of (or even completely) the functionality that is present today in Hardware-dependent Software (HdS), Real-Time Operating System (RTOS) and Middleware [Senouci, B., Bouchhima, A., Rousseau, F., Pétrot, F., and Jerraya, A., “Prototyping Multiprocessor System-on-Chip Applications: A Platform-Based Approach,” IEEE Distributed Systems Online, vol. 8, no. 5, 2007, art. no. 0705-o5002]. Nevertheless, modern HdS, RTOS and Middleware solutions are very generic and are not customized according to the specific needs of the software applications that run on top of them and according to the underlying hardware platform components.

Also Component-Based-Design is very relevant. This technology is currently applied on the design of Mikrokernels and enables the customization of the RTOS [Gai, P.; Abeni, L.; Giorgi, M.; Buttazzo, G., “A new kernel approach for modular real-time systems development”, 13th Euromicro Conference on Real-Time Systems, 2001, Vol., Iss., 2001, Pages:199-206]. Nevertheless, Mikrokernels and Component-Based-Design of RTOS in general do not address the issue of automatic customization, design and implementation of the final RTOS, which has to be performed manually by the embedded system designer.

Other design methodologies and tools that exploit a mixture of design-time and run-time information is currently available. These methodologies optimize the usage of memories [Gomez, J. I.; Marchal, P.; Bruni, D.; Benini, L.; Prieto, M.; Catthoor, F.; Corporaal, H., “Scenario-based SDRAM-Energy-Aware Scheduling for Dynamic Multi-Media Applications on Multi-Processor Platforms”, Workshop on Application Specific Processors (WASP), Istanbul, November 2002] and the usage of processing elements [Zhe Ma; Chun Wong; Peng Yang; Vounckx, J.; Catthoor, F., “Mapping the MPEG-4 visual texture decoder: a system-level design technique based on heterogeneous platforms”, Signal Processing Magazine, IEEE, Vol. 22, Iss. 3, May 2005 Pages: 65-74]. They also provide trade-offs between the resource usage of different hardware components according to Pareto spaces [Ch. Ykman-Couvreur, E. Brockmeyer, V. Nollet, Th. Marescaux, Fr. Catthoor, H. Corporaal, “Design-Time Application Exploration for MP-SoC Customized Run-Time Management”, Proceedings of the International Symposium on System-on-Chip, Tampere, Finland, November 2005]. Nevertheless, they rely on source-to-source transformations of the embedded software and are not able to deal with situations where the source code of the embedded software is not available at the design of the embedded system (as is the case with downloadable services).

Finally, the use of metadata is widely used today, mostly in the domain of embedded hardware. A relevant example is the use of the IEEE P1685 standard about the definition of the metadata format that characterizes each hardware component on an embedded platform. Nevertheless, this metadata information is used in a completely different context. Until now the hardware metadata are used to easily design, test and verify hardware platforms.

While [Alexandros Bartzas, Miguel Peon-Quiros, Stylianos Mamagkakis, Francky Catthoor, Dimitrios Soudris, Jose Manuel Mendias: Enabling run-time memory data transfer optimizations at the system level with automated extraction of embedded software metadata information. ASP-DAC 2008: 434-439, January 2008] describes the extraction of software metadata for one particular optimization design flow regarding optimized DMA data transfers, its repetitive use for a context with multiple optimization designs flow will lead to large set's of independent software meta data. Also influences between such optimization design flows are not discussed. Similar considerations can be made about [Stylianos Mamagkakis, Dimitrios Soudris, Francky Catthoor: Middleware design optimization of wireless protocols based on the exploitation of dynamic input patterns. DATE 2007: 1036-1041, April 2007] focusing on network statistics, which are relevant to memory optimizations for wireless protocol network applications. Again the context of multiple semantic kernel components or multiple optimizations flows are not considered. Similarly not in [Stylianos Mamagkakis, David Atienza, Christophe Poucet, Francky Catthoor, Dimitrios Soudris, Jose Manuel Mendias: Automated exploration of pareto-optimal configurations in parameterized dynamic memory allocation for embedded systems. DATE 2006: 874-875, March 2006] which discusses Pareto optimal trade-offs for customized dynamic memory management while [Stylianos Mamagkakis, David Atienza, Christophe Poucet, Francky Catthoor, Dimitrios Soudris: Energy-efficient dynamic memory allocators at the middleware level of embedded systems. EMSOFT 2006: 215-222, October 2006] discusses parameterizable components for energy efficient dynamic memory allocation. [David Atienza, Jose Manuel Mendias, Stylianos Mamagkakis, Dimitrios Soudris, Francky Catthoor: Systematic dynamic memory management design methodology for reduced memory footprint. ACM Trans. Design Autom. Electr. Syst. 11(2): 465-489 (2006), April 2006] discusses a single optimization flow for low memory footprint dynamic memory allocation. Also [Stylianos Mamagkakis, Christos Baloukas, David Atienza, Francky Catthoor, Dimitrios Soudris, Antonios Thanailakis: Reducing memory fragmentation in network applications with dynamic memory allocators optimized for performance. Computer Communications 29(13-14): 2612-2620 (2006), August 2006] discusses an optimization flow for low memory footprint and high performance dynamic memory allocation. [David Atienza, Stylianos Mamagkakis, Francesco Poletti, Jose Manuel Mendias, Francky Catthoor, Luca Benini, Dimitrios Soudris: Efficient system-level prototyping of power-aware dynamic memory managers for embedded systems. Integration 39(2): 113-130 (2006), March 2006] discusses the modeling aspects for dynamic memory allocation components. [Stylianos Mamagkakis, Christos Baloukas, David Atienza, Francky Catthoor, Dimitrios Soudris, José M. Mendías, Antonios Thanailakis: Reducing Memory Fragmentation with Performance-Optimized Dynamic Memory Allocators in Network Applications. WWIC 2005: 354-364, May 2005] discusses an optimization flow for low memory footprint and high performance dynamic memory allocation. [David Atienza, Stylianos Mamagkakis, Francky Catthoor, Jose Manuel Mendias, Dimitrios Soudris: Dynamic Memory Management Design Methodology for Reduced Memory Footprint in Multimedia and Wireless Network Applications. DATE 2004: 532-537, February 2004], [David Atienza, Stylianos Mamagkakis, Francky Catthoor, Jose Manuel Mendias, Dimitrios Soudris: Reducing memory accesses with a system-level design methodology in customized dynamic memory management. ESTImedia 2004: 93-98, September 2004] discusses an optimization flow for low memory footprint dynamic memory allocation.

[David Atienza, Stylianos Mamagkakis, Francky Catthoor, Jose Manuel Mendias, Dimitrios Soudris: Modular Construction and Power Modelling of Dynamic Memory Managers for Embedded Systems. PATMOS 2004: 510-520, September 2004] discusses the modeling aspects for dynamic memory allocation components.

### SUMMARY OF CERTAIN INVENTIVE ASPECTS

Certain inventive aspects aim to reduce considerably the design time of an embedded system, which is comprised of software and hardware components. This will be performed with our proposed Semantic Kernel (or run-time management system, resource management system), which is a software layer between the embedded software applications and the hardware platform. In effect the Semantic Kernel aims to increase the virtualization level of the hardware resources and/or decrease the mapping design effort of the embedded software on the hardware resources.

At the same time, the Semantic Kernel aims to reduce at run-time the resource usage of embedded software on a given hardware platform. Resources considered are memory footprint, bandwidth of the on-chip interconnect, energy, cycle budget of individual processing elements, etc.

Finally, the reduction of design time and the reduction of resource usage will be done without a complete knowledge at design-time of the resource needs of the embedded software and the available hardware resources. The Semantic Kernel will be customizable according to metadata at design-time and adaptable to metadata at run-time. Finally, the Semantic Kernel will be self-adaptable according to logs of metadata changes at run-time.

Certain inventive aspects provide a solution for a context wherein multiple optimizations must be considered while keeping the overhead manageable and including interactions.

Certain inventive aspects propose effective solutions for the automated design of a software layer between embedded software applications and embedded hardware platforms. These hardware platforms include Single-Processor and heterogeneous Multi-Processor Systems-on-Chip (MPSoC). The proposed software layer is able to manage efficiently at run-time the usage of the resources present on the hardware platform by exploiting relevant metadata information, which characterizes the software and hardware aspects of the embedded system. We call the proposed software layer ‘Semantic Kernel’. The individual parts of the Semantic Kernel, which manage the individual resources on the hardware platform, are called ‘Semantic Kernel Components’ (or run-time sub managers) and they are connected through APIs, which we call ‘Semantic Kernel Interfaces’. Finally, one inventive aspect includes a ‘Semantic Kernel Factory’, which automatically designs efficient Semantic Kernel Components and combines them accordingly with the Semantic Kernel Interfaces at design-time according to the metadata information that is present at design-time. The customized Semantic Kernel Components are then able to adapt and self-adapt according predefined metadata scenarios and metadata information monitored at run-time.

The Semantic Kernel exploits all the information that is available to the embedded system designer at design-time with the use of metadata that represent the resource requirements and the available resources of the software and hardware components, which are going to be used on each specific embedded system design. Thus, the Semantic Kernel increases the efficiency of resource utilization through customization according to metadata with mixed design-time/run-time methodologies, instead of providing one-size-fits-all solutions at run-time.

The Semantic Kernel Factory addresses the shortcoming of the state of the art by automatically customizing the Semantic Kernel Components according to the metadata information that is coupled with each software component and each hardware component at design-time. Also, during run-time the Semantic Kernel Components are further configured by adapting and self-adapting according to predefined metadata scenarios and the monitored metadata at run-time.

The Semantic Kernel bypasses the prior-art shortcomings by being an individual abstraction layer between the source code of the embedded software applications and the hardware platform. This is very important because the Semantic Kernel can be designed and implemented as individual, parameterizable Semantic Kernel Components, which can self-adapt at run-time without the presence of all the relevant information at design-time. This self-adaptation is facilitated by the use of metadata with a specific format, which can be linked to each downloadable software service and thus can configure further and self-adapt the Semantic Kernel Components, which are responsible for the resource management of the downloaded software service.

We further use the same metadata for customization, adaptation and self-adaptation of the resource management and thus the functionality of the Semantic Kernel Components. Additionally, we extend for the first time the concept of metadata also in the domain of embedded software application components and exploit those metadata in conjunction with the metadata extracted and monitored from the hardware components. We should also note that the term metadata is heavily overloaded and mostly associated with websites. The use of metadata in websites by Internet browsers is completely out of the context of the description.

Certain inventive aspects use for the first time a combination of technologies:
Extraction of hardware metadata at design-time
Monitoring of hardware metadata at run-time
Extraction of software metadata at design-time
Monitoring of software metadata at run-time
Component based design
Interfaces technology
Scenario based optimizations
Pareto space management
Memory management methodologies
Processing elements management methodologies
Bandwidth management methodologies
Energy management methodologies

With the combination of the aforementioned technologies, a number of new design methodologies are invented:
1. Customization of Semantic Kernel Components at design-time
2. Adaptation of Semantic Kernel Components at design-time and at run-time
3. Self-adaptation of Semantic Kernel Components at run-time

These three design methodologies are also deployed in three respective stages: (i) purely during design-time, (ii) both during design-time and run-time (iii) and purely during run-time. The output of the design methodologies is the Semantic Kernel.

As can be seen in FIG. 1, the Semantic Kernel manages the resource usage between the resource requests of the embedded software applications and the availability of resources on the embedded hardware platform. The Semantic Kernel can provide trade-offs on the usage of various resources (e.g., Energy consumption VS Memory footprint, Memory footprint VS Bandwidth usage, etc.) by switching at run-time between a number of Pareto optimal implementation. Each Pareto optimal implementation is actually a specific combination of SKCs, which are parameterized accordingly. Additionally, a number of SKC combinations are selected at design and are customized accordingly by inserting the parameter values that match the metadata information of each software and hardware component. These parameters can also change at run-time according to the metadata information which is monitored on the APIs with the software application components and hardware components.

Note that in FIG. 1, we show only an example of the possible combinations of software application components and hardware components. The Semantic Kernel is not restricted to the specific combination used in this example.

Certain inventive aspects relate to a method for generating a run-time manager (real-time operating system), executing on a processor platform (possibly a multiprocessor platform being parallel architecture having at least two processors) and steering the execution of one or more applications on the processor platform, comprising: loading first information (preferably in a standardized predetermined, possibly even compressed format) describing characteristics of at least one of the applications; and generating the run-time manager, based on the first information (the run-time manager exploiting the multiprocessor characteristics in case of a multiprocessor platform e.g. by exploiting task migration between processors).

Potentially the method further comprising loading second information describing characteristics of the processor platform, wherein the generation of the run-time manager further being based on the second information (the second information may be even variable in case the processor platform is a hardware reconfigurable platform).

Preferably the process of generating the run-time manager comprise: loading a plurality of predetermined run-time manager components; and selecting (e.g. by on/off switching) those run-time manager components, suitable for the one or more applications to be executed on the processor platform, the selection being based on the first information. The selecting further selects those components being suitable for the processor platform, the selection being based on the second information. Thereafter the selected components (e.g. parametrized components) being further customized for the one or more applications to be executed on the processor platform, the customization being based on the first information.

Again the selected components can be being further customized for the processor platform, the customization being based on the second information.

The process of generating the run-time manager may further comprising generating suitable interfaces between the selected components.

In an embodiment the first and/or second information being described in XML.

Preferably the implementation of the run-time manager and the run-time manager components are described in an object-oriented language (e.g. C++ or Java).

Note that the run-time manager is made suitable for embedding in an operating system, operating on the processor platform. Hence the run-time manager or run-time management system or resource manager, executes partially tasks as found in real-time operating systems.

The generating is being performed off-line or on-line/run-time.

The generating can also be performed for a plurality of scenario's (user requirements, set of deployable applications), thereby generating a plurality of run-time managers, and further comprising: on-line/run-time detection of the applicable scenario and exploiting the related generated run-time manager.

Note that the run-time manager can be determined based on a virtualization of the processor platform. The processor Platform is possibly a multiprocessor platform being parallel architecture having at least two processors in which case the run-time manager exploiting the multiprocessor characteristics in case of a multiprocessor platform e.g. by exploiting task migration between processors.

First information in a standardized predetermined format can be compressed.

The application might be dynamic (e.g. capable to receive user inputs and/or environmental inputs).

In a particular example the run-time manager is handling at least the dynamic memory allocation within the processor platform.

Finally certain inventive aspects relate to the use of a standardized predetermined format describing characteristics of at least one of the application for the run-time management, such format not being a mere concatenation of what is needed for each of the sub manager/components (treating different aspect of the run-time management) of the run-time manager but properly designed such that information sharing is performed and even in a more advanced embodiment the actual use of the same information for the parametrizable run-time manager components within a single run-time submanager. This will result in the fact that information comprises less than the sum of the run-time sub manager specific information sets and preferably even less than half or even more preferably less than 20% than such set.

Further certain inventive aspects make explicit that although a type of abstraction is introduced for the software, which could lead to an understanding that such abstract information is fixed, some inventive aspects on the contrary make explicit that the run-time behavior of the application requires updating of the meta data if one or more of the run-time aspects or other optimizations or design flows lead to changes.

In another aspect, a method of automated generating at least part of a run-time manager is disclosed, the run-time manager suitable for executing on one or more processor platform and steering the execution of one or more applications on the processor platform, wherein at least one of the applications comprising embedded software and/or being dynamic and wherein the processor platform comprising a plurality of resources. The method comprises loading a first information in a standardized predetermined format describing characteristics of at least one of the applications. The method further comprises generating the run-time manager, based on the first information, the run-time manager comprising at least two run-time sub-managers, each handling the management of a different resource. The information needed to generate one of the two run-time sub managers shares in part the same information needed to generate the other of the two run-time managers.

In another aspect, a system for automated generating at least part of a run-time manager is disclosed, the run-time manager suitable for executing on one or more processor platform and steering the execution of one or more applications on the processor platform, wherein at least one of the applications comprising embedded software and/or being dynamic and wherein the processor platform comprising a plurality of resources. The system comprises a loading module configured to load a first information in a standardized predetermined format describing characteristics of at least one of the applications. The system further comprises a generating module configured to generate the run-time manager, based on the first information, the run-time manager comprising at least two run-time sub-managers, each handling the management of a different resource. The information needed to generate one of the two run-time sub managers shares in part the same information needed to generate the other of the two run-time managers.

In another aspect, a method of realizing improved execution of an application on a processor platform is disclosed. The method comprises loading a first information in a standardized predetermined format describing characteristics of the application. The method further comprises performing at least two steps of improving the execution of the application, each of the steps acting on essentially a different aspect of the execution, while each of the steps essentially exploits at least partially the same part of the first information.

In another aspect, a system for realizing improved execution of an application on a processor platform is disclosed. The system comprises a loading module configured to load a first information in a standardized predetermined format describing characteristics of the application. The system further comprises a performing module configured to perform at least two steps of improving the execution of the application, each of the steps acting on essentially a different aspect of the execution, while each of the steps essentially exploits at least partially the same part of the first information.

In another aspect, a method of at run-time realizing improved execution of an application on a processor platform is disclosed. The method comprises executing an application on a processor platform in accordance with a first set of settings. The method further comprises monitoring characteristics of the application during the execution and storing the characteristics in an information set in a predetermined standardized format. The method further comprises interrupting the execution of the application based on the monitored characteristics. The method further comprises performing at least two steps of improving the execution of the application, each of the improvement steps acting on essentially a different aspect of the execution, each of the improvement steps using at least partially the same part of the information, the improvement steps thereby generating a second set of settings. The method further comprises executing the application on the processor platform in accordance with the second set of settings.

In another aspect, a system for at run-time realizing improved execution of an application on a processor platform is disclosed. The system comprises an executing module to execute an application on a processor platform in accordance with a first set of settings. The system further comprises a monitoring module configured to monitor characteristics of the application during the execution and storing the characteristics in an information set in a predetermined standardized format. The system further comprises an interrupting module configured to interrupt the execution of the application based on the monitored characteristics. The system further comprises a performing module configured to perform at least two steps of improving the execution of the application, each of the improvement steps acting on essentially a different aspect of the execution, each of the improvement steps using at least partially the same part of the information, the improvement steps thereby generating a second set of settings. The system further comprises an executing module configured to execute the application on the processor platform in accordance with the second set of settings.

In another aspect, the use of information, associated with and describing characteristics of at least one application is disclosed. The information is provided in a standardized predetermined format, and suitable for generating in a automated manner at least part of a run-time manager, the run-time manager suitable for executing on one or more processor platform and steering the execution of one or more applications on the processor platform, wherein at least one of the applications partly comprising embedded software and/or being dynamic and wherein the processor platform comprising a plurality of resources, wherein the run-time manager comprises at least two run-time sub-managers, each handling the management of a different resource, each run-time sub-manager requiring a run-time sub-manager specific information set, the run-time sub-manager specific information set being derivable from the information while the information comprises less than the sum of the run-time sub-manager specific information sets.

In another aspect, a method of run-time execution of at least one application on a processor platform under support by a run-time manager is disclosed. The run-time manager is suitable for executing on one or more processor platform and steering the execution of one or more applications on the processor platform, wherein at least one of the applications comprises embedded software and/or being dynamic and wherein the processor platform comprising a plurality of resources, wherein the run-time manager comprises at least two run-time sub-managers, each handling the management of a different resource, the settings of the run-time manager being partly derived from information describing characteristics of at least one application and being provided in a standardized predetermined format, wherein when changes in at least one of the run-time sub-manager occur, the information is being updated in accordance with the behavior of the application as influenced by the change.

In another aspect, a processor platform is disclosed. The processor platform comprises a plurality of resources and a memory, wherein at least part of the memory being allocated for storing information associated with and describing characteristics of at least one application, the information being provided in a standardized predetermined format, and used for handling run-time resource management for at least two of the resources while executing of one or more applications on the processor platform, wherein at least one of the applications partly comprising embedded software and/or being dynamic.

### BRIEF DESCRIPTION OF THE DRAWINGS

FIG. 1 illustrates overview of the semantic kernel.

FIG. 2 illustrates overview of the 3 stages of the semantic kernel design.

FIG. 3 illustrates semantic kernel components clustered in resource management functions.

FIG. 4 illustrates Pareto surface containing Pareto optimal operational points.

FIG. 5 illustrates customization of semantic kernel components.

FIG. 6 illustrates run time adaptation of semantic kernel components (bottom part) according to different scenarios pre-calculated at design time (top part).

FIG. 7 illustrates self-adaptation of semantic kernel components.

FIG. 8 illustrates implementation of semantic kernel components for dynamic memory management (middle part) of deficit round robin (DRR) and 802.11b (WiFi) software applications (top part) for a specific hardware platform (bottom part).

FIG. 9a-9b illustrate design time optimization flows without software metadata concept usage and design time optimization flows with software metadata concept usage respectively.

FIG. 10a-10b illustrate run time optimization of software components without software metadata concept usage and run time optimization of software components with software metadata concept usage respectively.

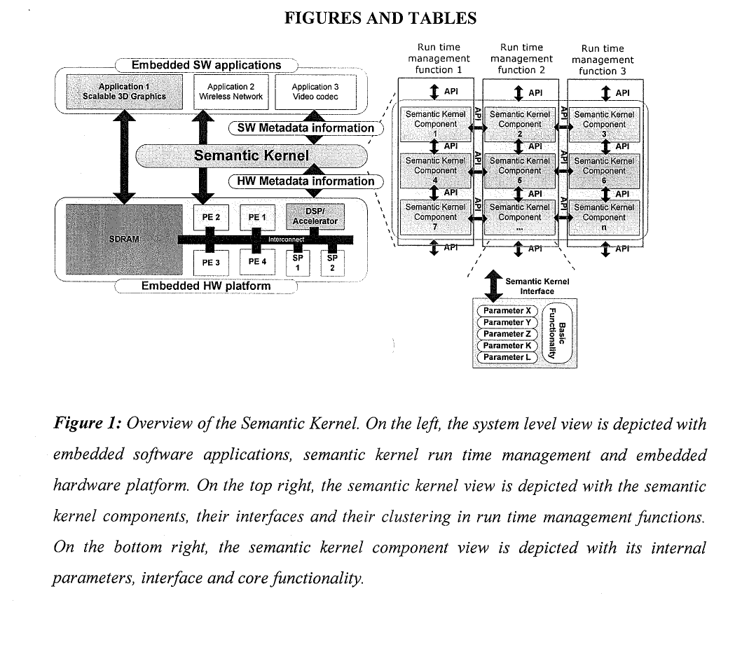

### DETAILED DESCRIPTION OF CERTAIN ILLUSTRATIVE EMBODIMENTS

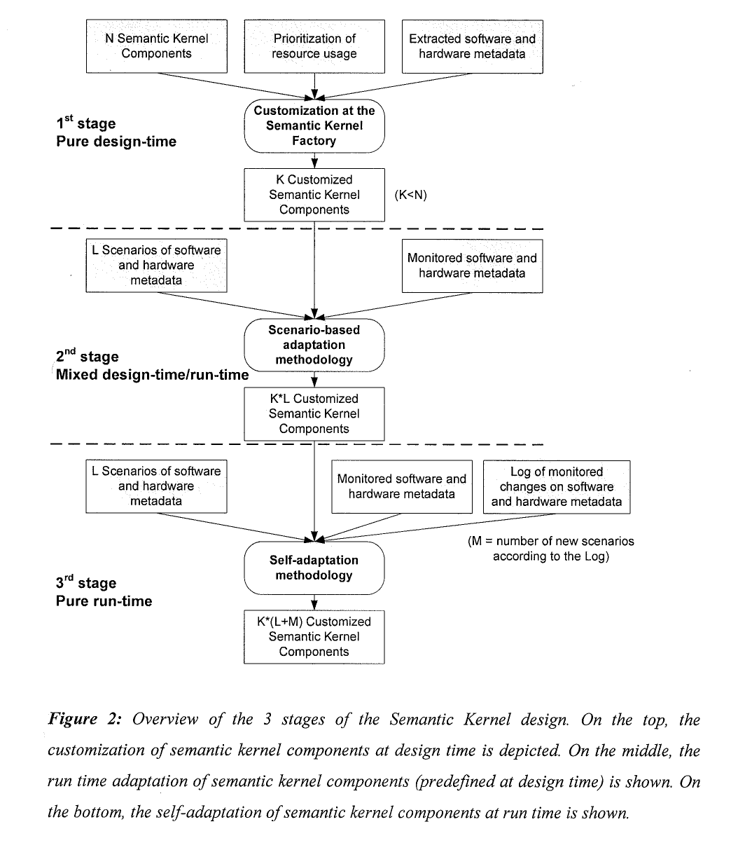

As can be seen in FIG. 2, the Semantic Kernel is designed and implemented in three stages with the:
Customization of Semantic Kernel Components at design-time
Adaptation of Semantic Kernel Components at design-time and at run-time
Self-adaptation of Semantic Kernel Components at run-time

In the first three subsections we will analyze the three stages, respectively, and in the fourth subsection we will show the implementation of the three stages in a real life example of customization, adaptation and self-adaptation of Semantic Kernel Components for Dynamic Memory Management of wireless network software applications on a complex hardware memory hierarchy.

### A. Design-time: Customization of Semantic Kernel Components

In the first stage, the Semantic Kernel Factory takes as input: (i) prioritization of the resource usage to be minimized (ii) all the available Semantic Kernel Components, (iii) the extracted software and hardware metadata. The output is a group of customized Semantic Kernel Components. As shown in FIG. 2, we assume that all the available Semantic Kernel Components are N and the group of customized Semantic Kernel Components are K, where K is a subset of N.

Detailed Description of Inputs:

i) The prioritization of the resource usage to be minimized is an ordering of the importance of each resource in the embedded system. This ordering is important, because according to our Pareto space, some resource usage can be reduced in the expense of increasing another resource usage. The embedded system designer can give in a XML file the order of the resources that are most critical for the design of the embedded system (e.g., energy consumption is more important than memory footprint) or the values of resources that are restricted in the design. This XML file can also contain absolute or ranged values of the required resource usage (e.g., 1-2 Mbytes of memory footprint and less than 2 seconds execution time).

ii) All the available Semantic Kernel Components are software components written in an object oriented language, like C++ and Java, which have an explicit interface and functionality. These software components can be linked with each other through a specific API, which is declared with each component. The combination of a set of linked software components performs a specific function, which manages the usage of a specific resource. Each software component is configurable through parameters (i.e., data values which can change the algorithmic behavior of the software component).

iii) Metadata is the information which either characterizes the resource needs of the embedded software or the available resources on the hardware platform. The hardware metadata is extracted at design-time by parsing the IEEE P1685 XML schema associated with each hardware component. The software metadata is extracted at design-time from each software component with either the use of source code analysis tools or with extensive profiling of the source code using a set of characteristic and realistic inputs [Poucet, C., Atienza, D. and Catthoor, F., “Template-Based Semi-Automatic Profiling of Multimedia Applications”. In the Proceedings of the International Conference on Multimedia and Expo (ICME 2006), pages 1061-1064, IEEE Signal Processing, 2006.]. The software metadata is written in an XML file using an extended IEEE P1685 XML schema. Finally, each software and hardware component of the embedded system should come with an associated XML file, which describes its contribution to the total resource needs or the total resources available. Metadata, which is relevant but can not be extracted at design-time, is denoted as ‘unknown’. Metadata can have a fixed value, in this case they are design restrictions of the software/hardware components, or metadata can have a range of values, in this case they are design options of the software/hardware components. Metadata, which is relevant but can not be extracted at design-time, is denoted as ‘unknown’.

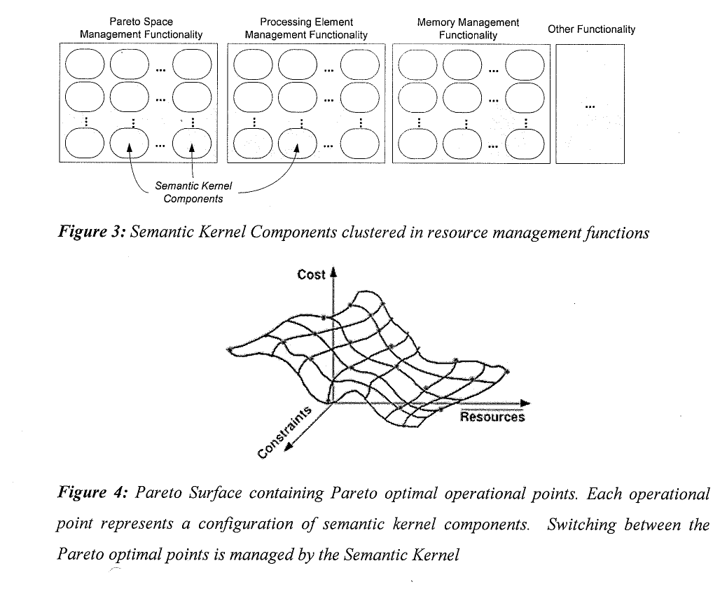

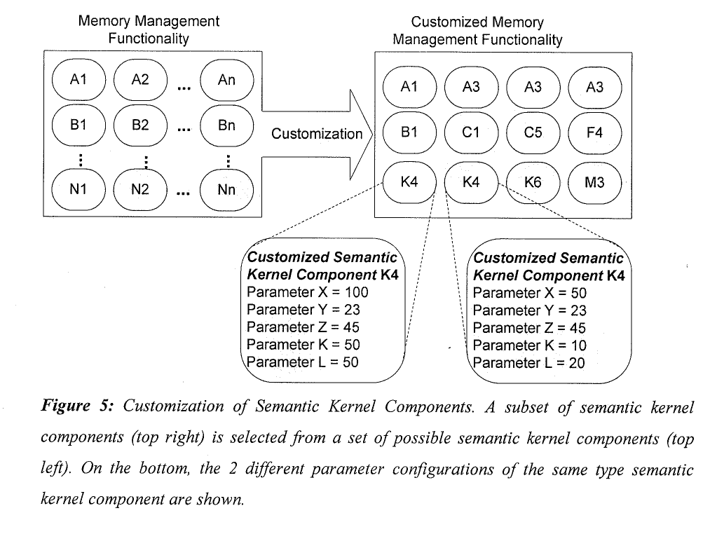

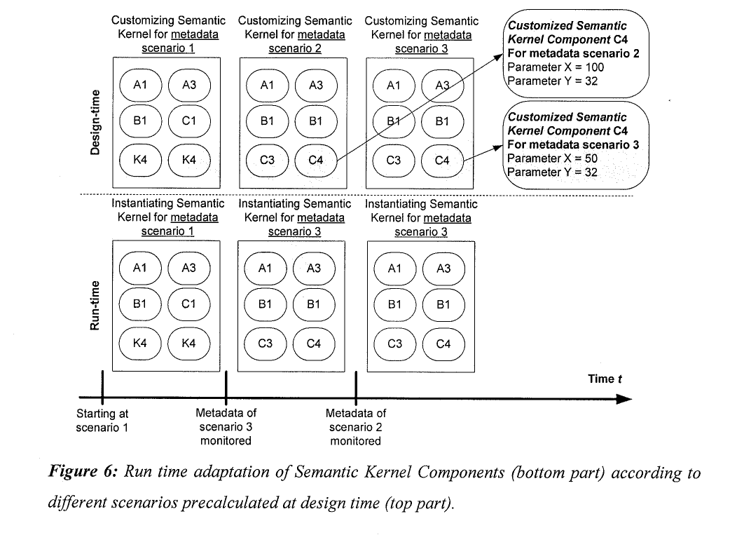

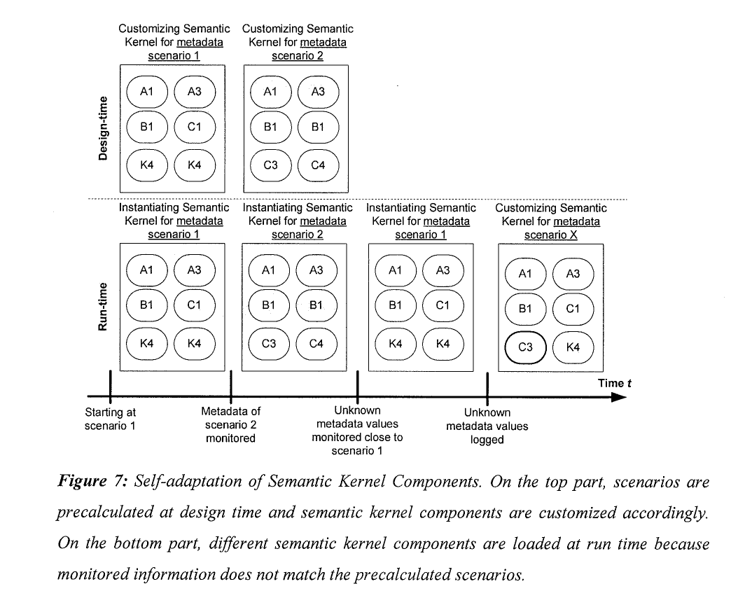

The aforementioned inputs will be given to the Semantic Kernel Factory, which will customize the Semantic Kernel Components at design-time. As can be seen in FIG. 3, each Semantic Kernel Component belongs to specific function of the Semantic Kernel. These functions manage the individual hardware resources of an embedded system. For example, the Processing Elements function manages the cycle budget of DSPs, General Purpose Processors, GPUs, Accelerators, etc. It includes Semantic Kernel Components, which are responsible for scheduling of tasks, allocation of tasks to specific processors, task-migration policies, voltage scaling, etc. Only for scheduling there can be multiple Semantic Kernel Components defined: Earliest Deadline First, Round Robin, Weighted Round Robin, Rate Monotonic, Slot shifting, etc. Therefore each Semantic Kernel Component can be implemented as an object of a class with custom interfaces implemented as method calls.

Also, the Pareto Space management function is very important because it manages globally the trade-offs between the usage of the hardware resources. As can be seen in FIG. 4, a multi-dimensional Pareto surface is produced by the Pareto optimal points. Each point represents a Pareto optimal implementation of the Semantic Kernel (i.e., a unique combination of Semantic Kernel Components with specific Parameter values). At design-time the Semantic Kernel Factory selects an implementation according to the prioritization of the resource usage to be minimized (or the design constraints of the embedded system). At run-time the Semantic Kernel switches between Pareto optimal implementations according to the combination of resource needs of all the embedded software applications at a given time and according to the resources available on the hardware platform.

We should note that the first stage has the most impact in the case of an embedded system design, when all the resource needs of the software and all the available hardware resources are known at design-time and do not vary much at run-time. This means that the software and hardware metadata are fixed at design-time. For example, this is the case for embedded systems that do not accept input from the user and/or the environment during their execution and once they are started they repeat the same task in predefined loops.
*Custom function calls, POSIX OpenMP MPI CORBA OpenMax OpenGL etc.
**Metadata, which is relevant but can not be extracted at all during design-time, is denoted as ‘unknown’ and the respective Semantic Kernel Component customization as ‘default’.

### B. Design-time and Run-time: Adaptation of Semantic Kernel Components

In the second stage, one embodiment takes as input: (i) the group of customized Semantic Kernel Components of stage one, (ii) scenarios of the software metadata and hardware metadata and (iii) the monitored changes on software and hardware metadata. The output is a number of groups of customized Semantic Kernel Components. As shown in FIG. 2, we assume that all the available Semantic Kernel Components are N and the group of customized Semantic Kernel Components are K for each metadata scenario that they are adapted for. Therefore, if the metadata scenarios are L, then the customized SKCs are K*L.

Detailed Description of Inputs:

i) The group of customized Semantic Kernel Components are essentially a subset of all the available Semantic Kernel Components, which were given as input in the first stage. Each component of this group is initialized and all its parameters are given a specific value in the first stage according to the metadata extracted at design-time.

ii) The scenarios of the software and hardware metadata are associated with software and hardware metadata, which were extracted in stage one and do not have one specific value, rather they have ranged values. This means that at design-time the designer can not extract a single value for each software and hardware metadata, instead he (or she) can extract by profiling and analysis a range of values. Each one of those values has a certain probability of instantiating at run-time according to changes of user actions and/or the environment. The metadata values, which have the highest probability of instating (usually more than 5%), are classified as scenarios. Obviously the scenarios of the software and hardware metadata have also a direct impact on the resource usage and the available resources of the embedded system. The scenarios are produced by a combination of source code profiling and analysis tools and are inserted in a XML file, which denotes the probability, range of metadata values and the touple of each input which triggers the change in the metadata value. This XML file is used by the Semantic Kernel Components in order to adapt at run-time according to the scenario that instates.

iii) As mentioned earlier, the metadata values can have ranges and one value is actually instantiated at run-time. The second stage takes as input the changes of the values of software and hardware metadata, which are monitored at run-time. In this way, the Semantic Kernel is aware which metadata value is valid at any given time frame and thus which scenario is instantiated. This information will trigger and guide the adaptation of the Semantic Kernel Components accordingly.

Note that for the case that the software and hardware metadata do not change values during run-time, the second stage is omitted. Therefore, the second stage has the most impact in the case of an embedded system design, when the resource needs of the software and the available hardware resources are not fully known at design-time and vary at run-time. Nevertheless, the different scenarios of resource needs and available resources should be available at design-time even though they instantiate at run-time. This means that the software and hardware metadata will have ranged values. Each range of metadata values will then be fragmented in respective predefined scenarios, which have a high possibility of instantiating at run-time. For example, this is the case for embedded systems that accept limited and predefined input from the user and/or the environment during their execution and they adjust the execution of different tasks accordingly. This is also the case for embedded systems, which implement their on-chip interconnect with a FPGA and are able to reconfigure it dynamically at run-time.

### C. Run-time: Self-adaptation of Semantic Kernel Components

In the third stage, one embodiment takes as input: (i) the group of customized Semantic Kernel Components of stage two, (ii) scenarios of the software metadata and hardware metadata of stage two, (iii) the new monitored changes on software and hardware metadata as in stage two and (iv) the log of monitored changes on software and hardware metadata. The output is a number of groups of customized Semantic Kernel Components. As shown in FIG. 2, we assume that all the available Semantic Kernel Components are N and the group of customized Semantic Kernel Components are K for each metadata scenario that is extracted at design-time. Nevertheless, the number of metadata scenarios changes according to the log of monitored metadata changes at run-time by M metadata scenarios. Therefore, if the new metadata scenarios are L+M, then the customized SKCs are K*(L+M).

Detailed Description of Inputs:
i) As described in input (i) of stage two.
ii) As described in input (ii) of stage two.
iii) As described in input (iiii) of stage two.
iv) The predefined scenarios of software and hardware metadata are not enough for the case of self-adaptation in the third stage. This means that the monitored changes of the software and hardware metadata values at run-time (as defined in the third input of stage two or three) are not part of the predefined scenarios or do not even fall within the predefined range of metadata values, which were extracted at design-time. In this case, the existing scenarios are either updated at run-time or new scenarios are calculated at run-time. These new scenarios are updated/calculated by the Semantic Kernel at run-time according to the logs of the changes that have been monitored on the values of the software and hardware metadata for a specific time frame. The time frame is specified by the embedded system designer and should guarantee the correct calibration the system (e.g., for wireless networks this is after the processing of 20,000 packets). This log information will trigger and guide the self-adaptation of the Semantic Kernel Components accordingly. Note that the number of new scenarios can be also negative, which means that some of the predefined scenarios are no longer used at run-time.

Note that for the case that the software and hardware metadata do not change values during run-time, the third stage is omitted. The third stage is also omitted if the software and hardware metadata change values during run-time only according to the predefined scenarios which are exploited in stage two. Therefore, the third stage has the most impact in the case of an embedded system design, when most of the resource needs of the software and the available hardware resources are not known at design-time and vary much at run-time. This means that unknown events trigger the usage of an unknown amount of resources, thus bounding the resource usage in a predefined worst-case scenario is extremely inefficient. Therefore, the software and hardware metadata are not known at design-time and they have to be monitored and logged by the Semantic Kernel for a period of time to define and update their values. For example, this is the case for very dynamic embedded systems, which accept constantly input from the user and/or the environment during their execution. These embedded systems also allow downloadable software services and hardware add-on cards which are defined by software and hardware developers much after the design and development of the embedded system.

D. Implementation of one embodiment in the Semantic Kernel Components for Dynamic Memory Management

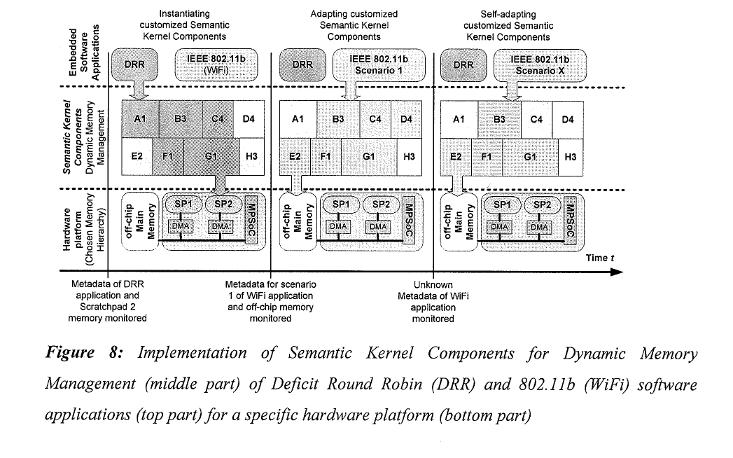

The semantic kernel components for Dynamic Memory management are presented as capital letters in FIG. 8 (e.g., A1 versus B1) and the semantic kernel component parameters are presented as numbers next to the capital letters in FIG. 8 (e.g., A1 versus A2).

### Detailed Example of Semantic Kernel Components for Dynamic Memory Management:

BlockSize:

We have developed a basic memory block structure that does not have just a single fixed size which is decided at design time. This means that during run-time the Dynamic Memory Manager can decide the size of the memory block that is used to accommodate the memory requested from the application. On the one hand, using a single fixed size for memory block structures would prove catastrophic for energy consumption, because it would increase the internal fragmentation at such levels, that huge energy-hungry memories would be needed by the Dynamic Memory Manager. For example, if the application requested 100 10-byte blocks and 100 200-byte blocks and the fixed block chosen size was 200 bytes, then 47.5% of the allocated space would be wasted in internal fragmentation. On the other hand, our Semantic Kernel Component can implement basic memory blocks with many different sizes. Therefore, it prevents internal fragmentation (by allocating memory blocks matching the requested size) and makes better use of smaller physical memories, which consume less energy.

PoolSize:

We have developed a system of memory pools, which can allocate memory blocks according to a specific memory size (e.g., 20-byte blocks) or memory size range (e.g., from 40-byte to 120-byte blocks) requested by the application. On the one hand, using a single pool for all memory block requests by the application would pose disadvantages in terms of energy consumption, mainly because it denies the ability to have quick access to commonly allocated block sizes. Therefore, the Dynamic Memory Manager would need much more memory accesses, in order to find the commonly allocated block size inside the single mixed block-size pool and thus would consume more energy. On the other hand, by using many pools based on block size request, we can categorize the memory blocks and provide easy allocation of the most ‘popular’ ones (which usually amount to 30% -90% of the total block requests), with just a few memory accesses, thus consuming less memory.

PoolConnection:

We have developed a pointer array structure to link the memory pools. This works like a table of contents, which can give access to a specific memory pool without going through all the available memory pools until it finds the most suitable. On the one hand, using a single or double linked list structure to connect the memory pools increases the memory accesses of the Dynamic Memory Manager, parsing from one pool to the next in order to find the one that it needs, and thus energy consumption increases. On the other hand, it is possible by using a more sophisticated control structure to access a specific memory pool with the use of a single memory access, thus limiting energy consumption waste.

BlockInfo:

We have developed a flexible header for the basic memory blocks, which can accommodate various fields according to the information that needs to be recorded. There are memory block designs that do not record the size of each block, which means that they are unable to coalesce/split blocks and thus they can not reduce fragmentation in applications with heavy-fragmentation outlooks. Also, there are other memory block designs that clutter each header with many fields and record information about block size, block status, pointers to many complementary lists etc. In this case, there are small memory blocks that the header can have four times the size of the actual allocated memory. In both cases, these Dynamic Memory Managers eventually need bigger energy-hungry memories to satisfy their requests. Our solution is to have a customized design of the header of the blocks in different pools, according to the size of the memory blocks and the fragmentation outlook of the application.

FIFO:

We have developed a first-in-first-out (i.e., FIFO) allocation and de-allocation scheme for the memory blocks inside the memory pools. We have concluded that for wireless network applications the FIFO is the best scheme for heap data, because our temporal locality measurements have showed that data that is created first, is allocated first and then it is freed first in order to be processed first. LIFO allocation and de-allocation behaviors for heap data is very rare (and therefore LIFO schemes are not recommended), because it is natural to match LIFO behavior with stack data, rather than heap data. QoS and QoE, which are increasing in popularity, only increase this trend and give an even bigger advantage to FIFO schemes, which require in this case fewer memory accesses to allocate and de-allocate a memory block and thus consume less energy. Therefore, LIFO is naturally optimized for stack data, while FIFO according to our experimental results is optimized for heap data.

FirstFit:

We have developed a first-fit allocation algorithm and a roving pointer structure, which enables also the use of a next-fit algorithm, wherever it is needed. This means that the Dynamic Memory Manager chooses the first free block that is available and has a size equal or bigger than the requested one. We have concluded that unlike the more popular best-fit algorithms, the first-fit and next-fit algorithms serve better the goal of low energy consumption. This happens because the internal fragmentation (that the best-fit algorithm usually prevents) is already very low if ‘many block sizes’ and ‘many pools based on size’ are used (like in the case of low energy that we are considering). But even so, the memory access overhead that the best-fit algorithm introduces is considerably high, thus increasing much the energy consumption. The memory accesses can be reduced further with the use of the roving pointer based on the specific locality outlook of each application.

ImmediateCoalescing:

We have developed coalescing support for the memory blocks inside the pools, thus enabling the merging of two small free blocks in a bigger single block. The Dynamic Memory Managers that do not support coalescing suffer extensive external fragmentation, because they can not satisfy big block requests, even if they have the available space in the form of two neighboring free memory blocks. Additionally, they suffer from increased memory accesses, because more free blocks are available (i.e., 2 free blocks instead of a single coalesced block) and thus traversed regardless of the fit algorithm used. This means that coalescing support is essential for the reduction of both the memory accesses and the memory footprint of the Dynamic Memory Manager, thus reducing the overall energy consumption.

BasicSplitting:

We have developed splitting support for the memory blocks inside the pools, thus enabling the splitting of one big free block to two smaller ones. In contrast to the coalescing support, we choose not to enable this function for all the blocks inside a pool. We only enable it for the ‘top block’ inside a pool (i.e., the block with the highest memory address). This is a decision that we take only for low-energy Dynamic Memory Manager. The Dynamic Memory Managers that do support extensive splitting suffer from a high number of memory accesses, which is attributed both to the memory access cost of the splitting mechanism and to the fact that more blocks are available (i.e., 2 split blocks instead of the initial block) and thus traversed regardless of the fit algorithm used. The reduction of the internal fragmentation (which the splitting mechanism usually achieves) is almost irrelevant in our case, because we use multiple mechanisms to prevent it (therefore it is already very low). These mechanisms include the combination of the ‘many block sizes’ and ‘many pools based on size’ Semantic Kernel Components. Therefore, we can further decrease the memory accesses, and thus the energy consumption, without compromising the low internal fragmentation level for our Dynamic Memory Manager. To conclude, we support only the most basic single splitting option and not the extensive splitting options that increase significantly the amount of memory accesses.

### Detailed Example of Semantic Kernel Component Parameters for Dynamic Memory Management:

PoolPhysicalLocation Parameter (Inside the PoolSize Semantic Kernel Component):

We have developed support for a heap location parameter, which can be assigned to any address range on any physical memory that our memory hierarchy supports. Therefore, this parameter gives us the ability to divide memory block requests to ‘popular’ and ‘unpopular’ and, then, satisfy them from heaps that reside in smaller physical memories rather than bigger more energy-hungry physical memories.

PoolLogicalLocation Parameter (Inside the PoolSize Semantic Kernel Component):

We have developed support for a freelist parameter, which can hold a list of only freed memory blocks dedicated to a specific size. This means that once a memory block is allocated to the application and then freed, instead of being placed back to the heap where it belonged, it is placed in a list (i.e., the freelist) and further requests for that block size are satisfied immediately from that list (which logically accommodates blocks from many address ranges). Therefore, this parameter gives us the ability to assign freelists to the most frequently requested memory block sizes and reduce the memory accesses (which are required for the allocation of this specific block size) to a minimum. In turn, the reduced minimum accesses result to significantly reduced energy consumption.

FitSize Parameter (Inside the FirstFit Semantic Kernel Component):

We have developed support for a parameter that limits the size that is considered a successful fit to the requested block size during an allocation procedure with a fit algorithm. For example, if we use a first fit algorithm and the application requests a 10-KB block size, then we can set the ‘fit-size’ parameter to 15 KBs and therefore the first-fit algorithm does not stop searching until it finds a block ranging between 10 and 15 KBs. Note that without this parameter, the first-fit algorithm would have considered a fit to the request even a 500-KB block. It becomes apparent that this parameter gives us the ability to limit the negative effects of the first-fit and next-fit algorithms, which is producing increased internal fragmentation. Therefore, the allocations can be satisfied using smaller, less energy hungry memories.

DepthSearch Parameter (Inside the FirstFit Semantic Kernel Component):

We have developed support for a parameter that limits the accesses that are needed in order to find a successful fit to the requested block size during an allocation procedure with a fit algorithm. For example, if we use a first fit algorithm and we set the DepthSearch parameter to 40%, then the algorithm continues accessing one memory block after another within the pool until it either finds a successful fit or traverses 40% of the blocks within the pool (if it still does not find a successful fit then it can start the search in another pool). Note that without this parameter the fit algorithm would continue traversing 100% of the blocks within the pool. This parameter augments even further the advantage of the first-fit and next-fit algorithms, which is the requirement of reduced accesses to find a successful fit. The further reduction of memory accesses, in turn, brings the further reduction of energy consumption.

CoalesceOnOff Parameter (Inside the PoolSize and BlockInfo Semantic Kernel Components):

We have developed support for a parameter that enables/disables the coalescing support within a specific memory pool and adjust the header size accordingly. For example, if we have two pools, one that satisfies requests for blocks smaller than 32-bytes (e.g., pool 1) and one for blocks bigger than 32-bytes (e.g., pool 2). Then, with this parameter we can enable coalescing only for pool 2 and have size information recorded (which is essential for coalescing) only in the blocks of the pool 2. Therefore, we can fine tune coalescing support and header size, thus we do not waste memory accesses for coalescing support in pools that we know that external fragmentation is low and we do not waste memory space for headers that are too big in relation to the blocks that they inhabit. Again, smaller memories and less memory accesses can reduce the energy consumption significantly.

MaxBlockSize Parameter (Inside the ImmediateCoalescing Semantic Kernel Component):

We have developed support for a parameter which limits the maximum size of the single memory block that can be produced after a coalescing action. For example, if a 50-KB block is freed next to an already free 120-KB block and we have set the ‘max-size’ parameter to 120-KB, then these 2 blocks will not be coalesced. Therefore, with this parameter we can limit the use of unnecessary coalescing actions (which need memory accesses in order to be performed), when we know the maximum size of the memory requests of a given application (e.g., in the case of the previous example, a coalesced 170-KB block would be useless, if the maximum requested size was 120-KB). In this way, we still achieve the minimum external fragmentation with the least coalescing actions.

### Detailed Example of Semantic Kernel Customization for Dynamic Memory Management (DRR and 802.11b Software Application Metadata, On-chip Scratchpad Memory Hardware Metadata):

Target is reducing the energy consumption.

On the on-chip memories, we should first make sure that we allocate the mostly used memory blocks. In the case of the network applications, the most ‘popular’ memory blocks are the ACK and MTU packets. These are the smallest and biggest allocated blocks respectively. Therefore, our custom DM allocator design includes the software module of supporting BlockSize and supports 2 sizes (namely the ACK packet size and MTU packet size). Additionally, our DM allocator design includes the module of PoolSize and has 2 pools based on 2 specific sizes (namely the ACK packet size and MTU packet size).

Then, we should make sure that the DM allocator prevents memory fragmentation as much as possible. This is done with the use of the PoolPhysicalLocation parameter. Namely, we reserve one heap for each pool and thus 2 distinct memory address ranges for the ACK and the MTU packets respectively. Now that we are sure that we have no fragmentation, we go on reducing the memory size and memory accesses further by not using the ImmediateCoalescing and BlockInfo software modules at all. This also means that the CoalesceOnOff parameter is set to ‘off’ for both pools. Finally, the FIFO and FirstFit are not used because we have chosen to use only one BlockSize per PoolSize, therefore they are obsolete. The PoolConnection used is an array of 2 elements pointing to the 2 PoolSize modules. The BasicSplitting module is used to be able to split the ‘top block’ in each pool. Note, that in the end there will be some MTU-packet-sized memory blocks that will not fit in the on-chip scratchpad. These, will be assigned to the off-chip memory with the use of the on-chip DM allocator for network applications.

The API between the Software Applications and Semantic Kernel is the malloc( ) free( ) function calls.

The API between the Semantic Kernel and the Hardware is the address range given to sbrk( ) function call.

The API between the Semantic Kernel Components is based on the function calls of abstract derived classes or mixins [Y. Smaragdakis, et al. “Mixin layers: Object-Oriented implementation technology for refinement and collaboration-based designs”. In Trans. on SW Engineering and Methodology, 2002.] with template C++} classes. We use the definition of mixins as a method of specifying extensions of a class without defining up-front which class exactly it extends. This approach allows easy and flexible combination of hierarchically layered Semantic Kernel Components for Dynamic Memory Management. Experimental results:

### E. Software Metadata for Design Time and Run Time Optimizations

One embodiment proposes to extend the concept of metadata beyond hardware (see IP-XACT hardware metadata) to the embedded software domain. The target is to improve the communication and efficiency of embedded software optimization tools and even begin to use more complex system level design optimization tool flows. The same type software metadata can then be used to provide software component optimizations at run time.

System-level integration and optimization of embedded systems is a highly challenging task. Different components are first optimized and then integrated with the use of multiple tool flows, which can not communicate with each other and can not share critical information, unless they belong to the same tool suite of the same tool vendor. Recently, the interoperability situation has improved in the domain of hardware platform composition tools with the use of IP-XACT, which is the official set of specifications of the SPIRIT consortium for hardware IP metadata and tool interfaces (i.e., IP-XACT). In this way, localized information from specific tools can be taken into account regarding its global impact to the whole system. Unfortunately, there is no such progress in respect with metadata specifications for the software components of an embedded system, which would play an enabling role for the interoperability of tools managing the software components integration and global system optimization. Additionally, with the definition and use by different tools of both software and hardware metadata, we could envision tighter integration and true system level optimizations.

One of the many obstacles that need to be overcome for the definition and use of software metadata is the fact that software behaves dynamically in ways, which are not always fully known at design-time and depend heavily on the system inputs. Unlike hardware which can be easily documented with a static metadata format (this is even the case for reconfigurable devices like FPGAs), software is a more flexible entity that is more likely to evolve considerably during run-time. Software libraries in C++, which implement flexible data structures (e.g., linked lists in STL), dynamic memory management (e.g., malloc) and schedulers in operating systems are all examples of software components that evolve at run-time and thus can not be easily specified with the use of metadata unless you define multiple scenarios or a single worst-case scenario.

Although it is clear that for different embedded software domains (e.g., multimedia, automotive, etc.) some types of metadata information are more applicable than others, different tools should be able to refer to a single software metadata format if they use (and possibly update) the same type of information. In order to minimize design-time overhead, this metadata information should be extracted automatically from the source code and provided in a separate file (e.g., written in XML) accompanying each software component. Therefore, an ecosystem of tools which extract metadata values from source code and tools which then use directly the extracted software metadata values is needed to drive this vision forward.

In one embodiment, we propose the design time extraction and run time monitoring of software metadata for embedded systems and their usage for optimizations both at design time and run time.

### Software Metadata for Design Time Optimizations

In this section, the definition and extraction for software metadata will be discussed in the context of different memory management optimization flows.

In order to define the metadata of software applications running on embedded systems, one has to look at the metrics and internal states of the embedded software. Any information regarding the behavior of an application that could potentially be used by any optimization tool must be included. For software applications this mainly concerns their resource requirements (memory footprint, memory bandwidth, cycle budget, dedicated hardware needs, etc), but also any applicable deadlines, dependencies on other software modules, events that trigger specific behavior, etc. Some examples are provided in Table 3 and Table 4. ‘Field name’ identifies the type of software metadata, ‘Explanation’ gives a short description of the software metadata and ‘Type’ gives the data type needed to store the metadata values.

TABLE 3
Example of software metadata type ‘Access entry’ used fordynamic
memory allocation optimizations (ie, only part of the complete
metadata format)
AccessEntry: Holds the metadata information regarding memory accesses

| Field name | Explanation | Type |
|---|---|---|
| accesses | The total number of accesses to this entity | Integer |
| reads | The total number of reads to this entity | Integer |
| writes | The total number of writes to this entity | Integer |
| activeness | The histogram of accesses in terms of time | Histogram |
| | | Integer |

TABLE 4
Example of software metadata type ‘Allocation entry’ used for memory
assignment optimizations (ie, only part of the complete metadata format)
AllocationEntry: Holds the metadata information
regarding memory allocations

| Field name | Explanation | Type |
|---|---|---|
| id. | The allocated identifier | AllocatedID |
| allocations | The total number of allocations | Integer |
| | of this entity | |
| deallocations | The total number of dealloca- | Integer |
| | tions of this entity | |
| maximumLiveBlocks | The maximum number of blocks | Integer |
| | that are alive of this entity | |
| maximumMem | The maximum footprint in time | Integer |
| | of this entity | |
| lifeness | The histogram of allocations in | Histogram |
| | terms of time | Integer |

In Table 3, the software metadata information regarding the memory allocation behavior of the software is illustrated. The number of allocations and deallocations, the maximum number of objects that are allocated at the same time and the histogram of allocations along time (lifeness) are the relevant metrics. For some software metadata entries, extra information can be included that requires both the access and allocation information to be present. In the case of Frequency entries (Table 4), which hold the information on the frequency of accesses per byte, information on both access and allocation behavior is guaranteed to be present.

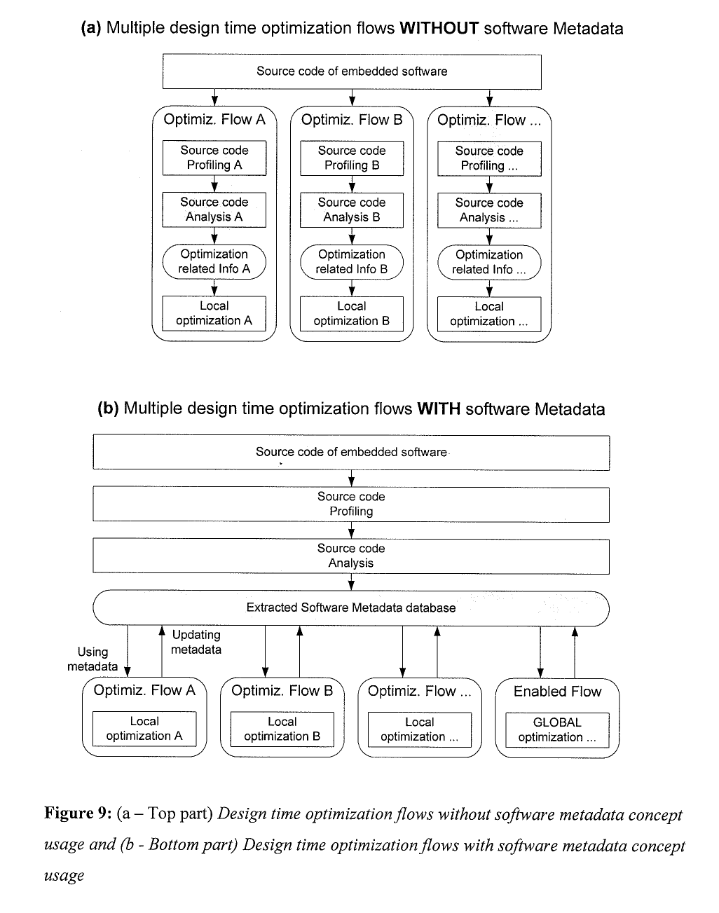

As illustrated in FIG. 9, the first process for obtaining the metadata employs the use of profiling. We first address what information needs to be profiled in order to enable the extraction of the required metadata. Once we have established what information needs to be profiled, we detail how we profile this data from an application. In the context of dynamic memory management, all the metadata that we collect can relate to the dynamic data behavior of the application. Therefore, it is important to profile this memory access and storage behavior so that later analysis can extract the proper metadata out of this information. More specifically, for the metadata that we target, we are interested in the following behaviors:
Allocation and deallocation of the dynamic memory, identified by the specific variable in the application.
Dynamic memory accesses (reads and writes) identified by the specific variable in the application.
Operations on dynamic data types, identified by the specific data type in question.
Control-flow paths that lead to the locations where these operations are being done.
Thread identifiers within which these operations occur.

Now that we've defined what information needs to be profiled, it is important to look at how it is profiled. As is obvious from the above list, all the information that needs to be profiled is information regarding the behavior of the dynamic

Once the profiling information has been extracted from the application, this information can be used in several different analyses steps that extract and compute the relevant metadata metrics. Various optimization methodologies make use of these metadata metrics in order to reduce energy consumption, as well as memory accesses and memory footprint. Different optimization tools will use specific parts of the global metadata set.

The analysis process is structured as a set of objects that perform specific analysis tasks. The main driver reads every entry from the profiling log file (of the previous process) and invokes in turn all the analysis objects to process it. After all the analysis objects have had the chance to compute the information related to the current entry, the main driver moves forward to the next profiling log entry.

Due to the way that our profiling information is gathered, it is not meaningful to have absolute timestamps, as the time that it requires to profile dominates (thus, clobbering) the runtime of the application. Therefore, our timing measure is defined in terms of the amount of profiling entries (of a specific type, such as allocation or access entries) that have passed since the beginning of execution. However, this is a good measure for the type of analysis that we do, due to the fact that all our metadata metrics, as well as analysis and optimization methodologies deal with dynamic memory accesses and not with the computation time. As a result, the relevant timing is based on events that alter the state of dynamic memory (e.g., allocations) or that define milestones for the memory subsystem (e.g., number of accesses).

The main driver of the analysis process performs the job of housekeeping the memory blocks that are currently allocated, the threads that are started or stopped, and the chain of scopes that are activated for the control-flow of each active thread. It is relevant to note that whenever a new thread is created, the scopechain from the parent thread is copied into the new one, to mirror the branching in the control-flow induced by the creation of threads.

The result of sharing a common software metadata format between different optimization flows reduces the design time needed to implement the flows and enables a global optimization flow.

Let us assume that three different optimization design flows (A, B and C) need to apply their new optimization methodologies. The first task they encounter is the characterization of the behavior of the application(s) they wish to optimize. Each optimization will need to allocate some time to profile, run and analyze it. The conventional way to perform this task is illustrated in FIG. 9(a). There all of the optimization flows perform the same processes—profiling and analysis (in different granularity). Moreover, the information produced by each of the flows will not be suitable for the other groups if they do not share a common representation.

With a common representation for the software metadata of these applications, the three independent optimization flows benefit from the characterization work performed by the others or even by a completely different flow that worked previously on the same application: The time required to perform the global profiling and information extraction work is less than the addition of the individual efforts (i.e., let f be the effort of performing profiling and analysis for one specific methodology, f (metadata)≦f(A)+f(B)+f(C)). Moreover, the fact that the relevant information is included in any analysis and that it has a common format allows to save time and apply it on the real optimization work. Once the information is extracted, the rest of the optimization flows will not need to invest any time on profiling and characterization (FIG. 9(b)).

### Software Metadata for Run Time Optimizations

The software metadata that has been extracted at design time using profiling and analysis methods can be used by both design time and run time optimizations. Therefore, the software metadata database extracted at design time can be used as starting point information for any relevant run time optimizations.

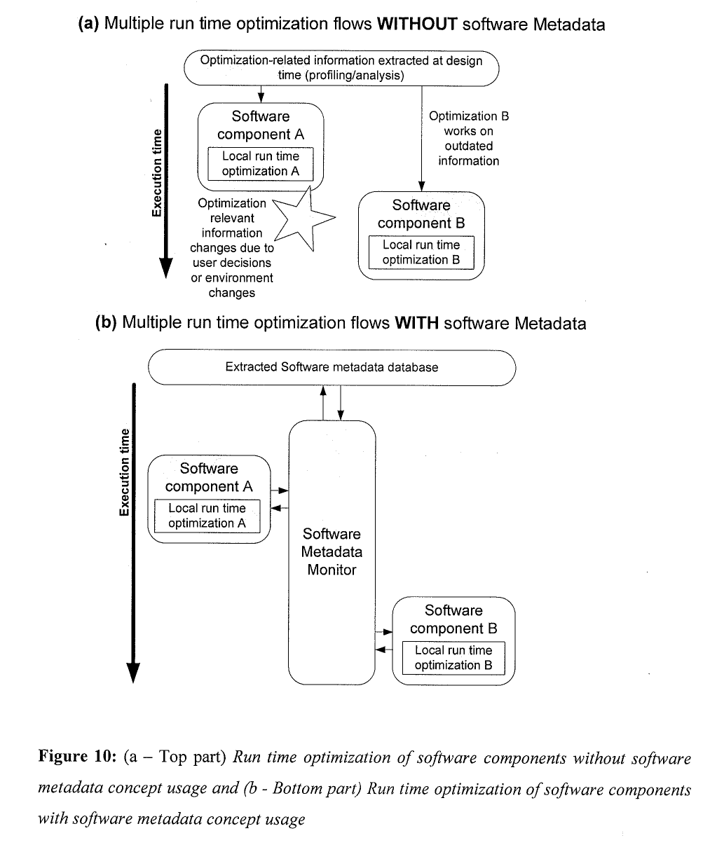

Nevertheless, this information will soon become outdated due to events coming from the user decisions, environment changes or from the internal state of the run time optimizations themselves (as seen in FIG. 10(a)). This means that those events would force execution branch changes at the control data flow graph of the source code executed in the embedded system. Note that this source code consists of the software application source code and the semantic kernel component source code, which is responsible for the resource management. Therefore, the software metadata values that change according to those execution branch changes need to be kept track of, because further run time optimizations should depend on the updated rather than the outdated information.

As shown in FIG. 10(b), one embodiment proposes a global software metadata monitor, which tracks any value changes of any software metadata type regardless of the software component that it optimizes (i.e., software application component or resource management software component) and then updates the software metadata database that was originally extracted at design time. This means that any further run-time optimization can refer to the consistent, updated metadata values and also develop new run time optimization strategies according to the history track of the metadata value changes (e.g., by using machine learning algorithms).

As mentioned earlier, the software metadata monitor can be a simple API that duplicates the value of an internal variable or a more complicated function that calculates the metadata value based on proxy internal values, as in the case of memory footprint and memory fragmentation, respectively.

Table 1 illustrates energy consumption reduction and memory accesses reduction with the use of semantic kernel for dynamic memory management functionality (compared to Linux). Table 2 illustrates execution time reduction and memory footprint reduction with the use of semantic kernel for dynamic memory management functionality (compared to Linux).

TABLE 1
Energy consumption reduction and memory accesses reduction
with the use of semantic kernel for dynamic memory management
functionality (compared to Linux).

| | Energy | | Memory | |
|---|---|---|---|---|
| | Consumption (mJoule) | | Accesses (10³) | |
| | DRR | WiFi | DRR | WiFi |
| Linux DMM | 35.1 | 162.4 | 7497.9 | 41.9 |
| Semantic Kernel DMM | 5.0 | 16.0 | 1126.7 | 8.8 |

| | | |
|---|---|---|
| Resource usage reduction | 87.9 | 81.9 |

TABLE 2
Execution time reduction and memory footprint reduction
with the use of semantic kernel for dynamic memory
management functionality (compared to Linux).

| | Execution | | Memory | |
|---|---|---|---|---|
| | Time (msec.) | | Footprint (10⁶ Bytes) | |
| | DRR | WiFi | DRR | WiFi |
| Linux DMM | 2.1 | 232.9 | 3.5 | 1.7 |
| Semantic Kernel DMM | 1.7 | 92.7 | 3.8 | 0.6 |

| | | |
|---|---|---|
| Resource usage reduction | 39.6 | 28.0 |

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A method of automated generating at least part of a run-time manager, the run-time manager suitable for executing on one or more processor platform and steering the execution of one or more applications on the processor platform, wherein at least one of the applications comprising embedded software and/or being dynamic and wherein the processor platform comprising a plurality of resources, the method comprising:
loading a first information in a standardized predetermined format describing characteristics of at least one of the applications; and
generating the run-time manager, based on the first information, the run-time manager comprising at least two run-time sub-managers, each handling the management of a different resource,
wherein the information needed to generate one of the two run-time sub managers shares in part the same information needed to generate the other of the two run-time managers.

2. The method of claim 1, wherein the generating of the run-time manger is performed for a plurality of scenarios, thereby generating a plurality of run-time managers, and further comprising on-line/run-time detection of the applicable scenario and exploiting the related generated run-time manager.

3. The method of claim 1, wherein at least one of the run-time sub managers comprises a plurality of parametrizable run-time manager components and the information needed to customize each of the run-time manager components by selecting the appropriate parameters is extracted from the same first information.

4. The method of claim 1, wherein the generating of the run-time manager comprises improving at least one of the run-time manager components, whereby the first information is updated after the improvement and the updated first information is exploited for generating another of the run-time sub managers.

5. A method of realizing improved execution of an application on a processor platform, the method comprising:
loading a first information in a standardized predetermined format describing characteristics of the application;
performing at least two steps of improving the execution of the application, each of the steps acting on essentially a different aspect of the execution, while each of the steps essentially exploits at least partially the same part of the first information.

6. The method of claim 5, wherein after execution of one of the improvement steps, the first information is updated, in accordance with the behavior of the application as influenced by the executed improvement step.

7. A method of at run-time realizing improved execution of an application on a processor platform, the method comprising:
executing an application on a processor platform in accordance with a first set of settings;
monitoring characteristics of the application during the execution and storing the characteristics in an information set in a predetermined standardized format;
interrupting the execution of the application based on the monitored characteristics;
performing at least two steps of improving the execution of the application, each of the improvement steps acting on essentially a different aspect of the execution, each of the improvement steps using at least partially the same part of the information, the improvement steps thereby generating a second set of settings; and
executing the application on the processor platform in accordance with the second set of settings.

8. The method of claim 7, wherein the executing, monitoring, interrupting and improvement are performed at least twice.

9. The method of claim 7, wherein after execution of one of the improvement steps, the information set is updated, in accordance with the behavior of the application as will be influenced by the executed improvement step.

10. The use of information, associated with and describing characteristics of at least one application, the information being provided in a standardized predetermined format, and suitable for generating in a automated manner at least part of a run-time manager, the run-time manager suitable for executing on one or more processor platform and steering the execution of one or more applications on the processor platform, wherein at least one of the applications partly comprising embedded software and/or being dynamic and wherein the processor platform comprising a plurality of resources, wherein the run-time manager comprises at least two run-time sub-managers, each handling the management of a different resource, each run-time sub-manager requiring a run-time sub-manager specific information set, the run-time sub-manager specific information set being derivable from the information while the information comprises less than the sum of the run-time sub-manager specific information sets.

11. The method of determining the suitable format for the information as defined in claim 10, comprising:
providing the run-time sub-manager specific information sets;
determining overlaps within the run-time sub-manager specific information sets.

12. The method of claim 11, further comprising:
determining which portion of run-time sub-manager specific information is computable from the other run-time submanager specific information

13. A method of run-time execution of at least one application on a processor platform under support by a run-time manager, the run-time manager suitable for executing on one or more processor platform and steering the execution of one or more applications on the processor platform, wherein at least one of the applications comprises embedded software and/or being dynamic and wherein the processor platform comprising a plurality of resources, wherein the run-time manager comprises at least two run-time sub-managers, each handling the management of a different resource, the settings of the run-time manager being partly derived from information describing characteristics of at least one application and being provided in a standardized predetermined format, wherein when changes in at least one of the run-time sub-manager occur, the information is being updated in accordance with the behavior of the application as influenced by the change.

14. A processor platform comprising:
a plurality of resources; and
a memory,
wherein at least part of the memory being allocated for storing information associated with and describing characteristics of at least one application, the information being provided in a standardized predetermined format, and used for handling run-time resource management for at least two of the resources while executing of one or more applications on the processor platform, wherein at least one of the applications partly comprising embedded software and/or being dynamic.

15. The processor platform of claim 14, further comprising a communication module configured to update the stored information in accordance with the behavior of the application if influenced by changes in the run-time resource management.
